(19) United States
(12) Patent Application Publication
(10) Pub. No.: US 2025/0167960 A1
(43) Pub. Date: May 22, 2025

(54) METHOD FOR DETERMINING RESOURCE ELEMENT GROUP BUNDLE AND METHOD FOR MAPPING RESOURCE ELEMENT GROUP BUNDLE

(71) Applicant: Beijing Xiaomi Mobile Software Co., Ltd., Beijing (CN)

(72) Inventor: Qun ZHAO, Beijing (CN)

(73) Assignee: Beijing Xiaomi Mobile Software Co., Ltd., Beijing (CN)

(21) Appl. No.: 18/723,958

(22) PCT Filed: Dec. 29, 2021
(86) PCT No.: PCT/CN2021/142630

§ 371 Date: Jan. 27, 2025

(51) Int. Cl. H04L 5/00

(52) U.S. Cl. CPC H04L 5/0053; H04L 5/0094

(57) ABSTRACT

A method for determining a resource element group (REG) bundle, includes: determining a mapping mode from an (REG bundle to an REG according to distribution of long-term evolution cell-dedicated reference signals (LTE CRSs) in a control resource set (CORESET); and determining the REG bundle in the CORESET according to the mapping method.

### CROSS REFERENCE TO RELATED APPLICATION

The present application is a U.S. National Stage of International Application No. PCT/CN2021/142630, filed on Dec. 29, 2021, the contents of all of which are incorporated herein by reference in their entireties for all purposes.

### BACKGROUND OF THE INVENTION

A long term evolution (LTE) system and a new radio (NR) system can coexist in the same spectrum at present. The LTE system is required to continuously transmit a cell-specific reference signal (CRS), which seriously interferes with the NR system.

### SUMMARY OF THE INVENTION

According to a first aspect of an example of the disclosure, a method for determining a resource element group (REG) bundle is provided. The method is performed by a terminal, and includes: determining a mapping method of the REG bundle to an REG according to distribution of long term evolution cell-specific reference signals (LTE CRSs) in a control resource set (CORESET); and determining the REG bundle in the CORESET according to the mapping method.

According to a second aspect of the example of the disclosure, a method for mapping an REG bundle is provided. The method is performed by a network-side device, and includes: determining a mapping method of the REG bundle to an REG according to distribution of LTE CRSs in a CORESET; and mapping the REG bundle in the CORESET according to the mapping method.

According to a third aspect of the example of the disclosure, a communication apparatus is provided. The communication apparatus includes a processor; and a memory configured to store a computer program. The computer program implements the method for determining an REG bundle when executed by the processor.

According to a fourth aspect of the example of the disclosure, a communication apparatus is provided. The communication apparatus includes a processor; and a memory configured to store a computer program. The computer program implements the method for mapping an REG bundle when executed by the processor.

According to a fifth aspect of the example of the disclosure, a non-transitory computer-readable storage medium is provided. The computer-readable storage medium is configured to store a computer program. The computer program implements steps of the method for determining an REG bundle when executed by a processor.

According to a sixth aspect of the example of the disclosure, a non-transitory computer-readable storage medium is provided. The computer-readable storage medium is configured to store a computer program. The computer program implements steps of the method for mapping an REG bundle when executed by a processor.

### BRIEF DESCRIPTION OF DRAWINGS

In order to describe technical solutions in examples of the disclosure more clearly, accompanying drawings required to be used in descriptions of the examples will be briefly introduced below. Apparently, the accompanying drawings in the following descriptions show merely some examples of the disclosure. Those of ordinary skill in the art can also derive other accompanying drawings from these accompanying drawings without making creative efforts.

FIG. 1 is a schematic flow diagram of a method for determining a resource element group (REG) bundle according to an example of the disclosure.

FIG. 2 is a schematic diagram of distribution of long term evolution cell-specific reference signals (LTE CRSs) according to an example of the disclosure.

FIG. 3 is a schematic diagram showing that a new radio physical downlink control channel demodulation reference signal (NR PDCCH DMRS) is in conflict with an LTE CRS according to an example of the disclosure.

FIG. 4 is a schematic diagram of mapping an REG bundle to an REG according to an example of the disclosure.

FIG. 5 is a schematic flow diagram of another method for determining an REG bundle according to an example of the disclosure.

FIG. 6 is a schematic flow diagram of yet another method for determining an REG bundle according to an example of the disclosure.

FIG. 7 is a schematic flow diagram of yet another method for determining an REG bundle according to an example of the disclosure.

FIG. 8 is another schematic diagram of mapping an REG bundle to an REG according to an example of the disclosure.

FIG. 9 is a schematic flow diagram of still another method for determining an REG bundle according to an example of the disclosure.

FIG. 10 is yet another schematic diagram of mapping an REG bundle to an REG according to an example of the disclosure.

FIG. 11 is a schematic flow diagram of a method for mapping an REG bundle according to an example of the disclosure.

FIG. 12 is a schematic flow diagram of another method for mapping an REG bundle according to an example of the disclosure.

FIG. 13 is a schematic flow diagram of yet another method for mapping an REG bundle according to an example of the disclosure.

FIG. 14 is a schematic flow diagram of yet another method for mapping an REG bundle according to an example of the disclosure.

FIG. 15 is a schematic flow diagram of still another method for mapping an REG bundle according to an example of the disclosure.

FIG. 16 is a schematic block diagram of an apparatus for determining an REG bundle according to an example of the disclosure.

FIG. 17 is a schematic block diagram of an apparatus for mapping an REG bundle according to an example of the disclosure.

FIG. 18 is a schematic block diagram of an apparatus for mapping an REG bundle according to an example of the disclosure.

FIG. 19 is a schematic block diagram of an apparatus for determining an REG bundle according to an example of the disclosure.

### DETAILED DESCRIPTION OF THE INVENTION

Technical solutions in examples of the disclosure will be clearly and completely described below with reference to accompanying drawings of the examples of the disclosure. Apparently, the described examples are merely some examples rather than all examples of the disclosure. All other examples derived by a person of ordinary skill in the art from the examples of the disclosure without creative efforts should fall within the protection scope of the disclosure.

Terms used in examples of the disclosure are merely to describe particular examples, and are not intended to limit examples of the disclosure. Singular forms such as “a”, “an” and “this” used in examples of the disclosure and the appended claims are also intended to include plural forms, unless otherwise clearly stated in the context. It should also be understood that the term “and/or” used here refers to and includes any or all possible combinations of one or more of associated listed items.

It should be understood that although terms “first”, “second”, “third”, etc. may be employed in examples of the disclosure to describe all types of information, such information should not be limited to these terms. These terms are merely used for distinguishing the same type of information from each other. For example, first information can also be referred to as second information and second information can also be referred to as first information similarly without departing from the scope of examples of the disclosure. Depending on the context, the word “if” as used here can be interpreted as “in a case that”, “when” or “in response to determining”.

For purposes of concision and ease of understanding, terms “greater than” or “less than” and “higher than” or “lower than” are used here to represent size relations. Those skilled in that art can understand that the term “greater than” also covers the meaning of “greater than or equal to”, the term “less than” also covers the meaning of “less than or equal to”, the term “higher than” also covers the meaning of “higher than or equal to”, and the term “lower than” also covers the meaning of “lower than or equal to”.

In the related art, in the process of detecting an NR physical downlink control channel (PDCCH), a terminal needs to assess the channel with the granularity of a resource element group (REG) bundle. At present, the REG bundle is mapped to an REG in a sequential order of a time domain and a frequency domain.

However, due to existence of the LTE CRS, the terminal in the related art cannot transmit an NR PDCCH demodulation reference signal (DMRS) on a resource element (RE) that has the LTE CRS, which is likely to result in variation in the numbers of REs corresponding to NR PDCH DMRSs used for channel estimation on different REGs in one REG bundle, and affects accuracy of the channel estimation accordingly.

In view of this, examples of the disclosure provide a method for determining a resource element group (REG) bundle and a method for mapping an REG bundle, which solve technical problems in the related art, and the disclosure relates to the technical field of communication

FIG. 1 is a schematic flow diagram of a method for determining a resource element group (REG) bundle according to an example of the disclosure. The method for determining an REG bundle shown in the example may be performed by a terminal. The terminal may be in communication with a network-side device. The terminal includes, but is not limited to, communication apparatuses such as a mobile phone, a portable android device, a wearable device, a sensor, and an Internet of things device. The network-side device includes, but is not limited to, a base station and a core network in communication systems, such as a fourth generation (4G) communication system, a 5G communication system and a 6G communication system.

As shown in FIG. 1, the method for determining an REG bundle may include S101 and S102.

S101: a mapping method of the REG bundle to an REG is determined according to distribution of long term evolution cell-specific reference signals (LTE CRSs) in a control resource set (CORESET).

S102: the REG bundle is determined in the CORESET according to the mapping method.

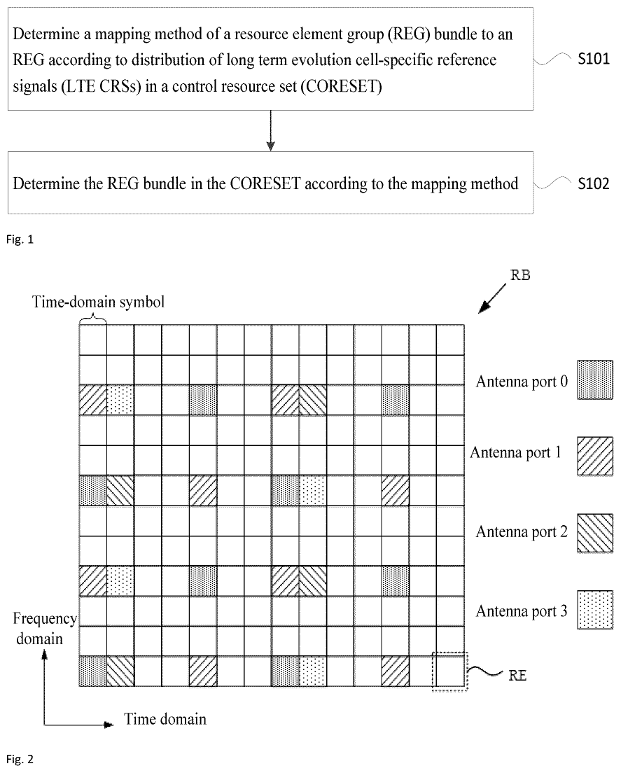

FIG. 2 is a schematic diagram of distribution of LTE CRSs according to an example of the disclosure.

In an example, an LTE cell identity (Cell ID) is equal to 0, and an LTE CRS supports 4 ports, that is, an antenna port 0, an antenna port 1, an antenna port 2 and an antenna port 3, for example. An LTE CRS corresponding to each antenna port occupies different resources. Resources occupied by LTE CRSs corresponding to the 4 antenna ports overlap each other to serve as a first resource.

As shown in FIG. 2, one resource block (RB) includes 14 symbols (such as orthogonal frequency division multiplexing (OFDM) symbols) in a time domain and 12 resource elements (RE) in a frequency domain. For example, on one symbol, numbers of the REs from bottom to top are RE #0 to RE #11. As shown in FIG. 2, the resources occupied by the LTE CRS include REs with numbers RE #0, RE #3, RE #6 and RE #9 on 1st, 2nd, 5th, 8th, 9th and 12th symbols.

It should be noted that the LTE CRS may be transmitted by an LTE network-side device, and the NR network-side device may also determine the resource occupied by the LTE CRS, for example, through communication with the LTE network-side device or based on a protocol. In addition, the terminal may also determine the resource occupied by LTE CRS. For example, the terminal may determine the resource occupied by LTE CRS based on the protocol.

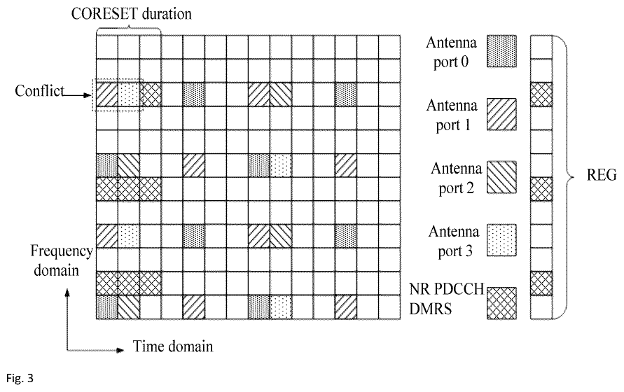

FIG. 3 is a schematic diagram showing that a new radio physical downlink control channel demodulation reference signal (NR PDCCH DMRS) is in conflict with an LTE CRS according to an example of the disclosure. As shown in FIG. 3, in an REG in the NR, a pattern of the NR PDCCH DMRSs is that the NR PDCCH DMRSs are distributed in RE #1, RE #5 and RE #9.

For example, if duration (duration) of the CORESET is 3 time-domain symbols, for example, first 3 symbols in the RB, when the NR PDCCH DMRS is located in the CORESET, the NR PDCCH DMRS conflicts with the LTE CRS on RE #9 of first 2 symbols in the RB, and merely the LTE CRS other than the NR PDCCH DMRS is transmitted on a conflicting RE.

FIG. 4 is a schematic diagram of mapping an REG bundle to an REG according to an example of the disclosure.

In the case shown in FIG. 3, the mapping of the REG bundle to the REG is performed in a sequential order of a time domain and a frequency domain in the related art, that is, the REG bundle is mapped to the REG based on the frequency domain at first and then the REG bundle is mapped to the REG based on the time domain.

As shown in FIG. 4, for example, a size of the REG bundle is three, that is, three REGs are mapped. When the REG bundle is mapped to the REG in the sequential order of the time domain and the frequency domain, a first symbol of the CORESET will be mapped to the REG at first, and then mapping to the REG continues based on the time domain until a last symbol of the CORESET. Since the CORESET duration includes three symbols, an REG bundle may be mapped completely in one RB. For example, REGs corresponding to the first three symbols in RB #n are mapped to REG bundle #n. By analogy, REGs corresponding to first three symbols in RB #n+1 are mapped to REG bundle #n+1, and REGs corresponding to first three symbols in RB #n+2 are mapped to REG bundle #n+2. REG bundle #n+1 and REG bundle #n+2 are not shown in the figure.

It is clear that the example merely shows the case that the size of the REG bundle is 3. If the size of the REG bundle is 6, when the REG bundle is mapped to the REG in the sequential order of the time domain and the frequency domain, a first symbol of the CORESET will be mapped to the REG at first, and then mapping to the REG continues based on the time domain until a last symbol of the CORESET. Since the CORESET duration includes 3 symbols, an REG bundle cannot be mapped completely in one RB, and the time domain may be considered later. That is, REG bundle may be mapped continuously on first 3 symbols of a next RB, such that one REG bundle may be mapped completely in two RBs. For example, in the case of the example shown in FIG. 4, one REG bundle is mapped on first three symbols of RB #n and RB #n+1.

It can be seen from the example that no matter what the size of the REG bundle is, after the mapping of the REG bundle to the REG is performed in the sequential order of the time domain and the frequency domain, numbers of REs corresponding to the NR PDCCH DMRSs in the first two symbols in the REG bundle are different from a number of REs corresponding to the NR PDCCH DMRSs in the third symbol in the REG bundle. As a result, the numbers of the REs corresponding to the NR PDCCH DMRS on different REGs in the REG bundle vary, thus reducing accuracy of channel estimation based on the REG bundle.

In an example, the mapping method includes at least one of the following: a first method: the REG bundle is mapped to the REG in a sequential order of a time domain and a frequency domain; or a second method: the REG bundle is mapped to the REG in a sequential order of a frequency domain and a time domain.

In an example, the distribution of the LTE CRSs includes at least one of the following: the LTE CRSs are distributed on all time-domain symbols in the CORESET; the LTE CRSs are distributed on none of all time-domain symbols in the CORESET; or the LTE CRSs are distributed on one part of time-domain symbols in the CORESET (the LTE CRSs are not distributed on the other part of time-domain symbols).

In an example, based on the distribution of the LTE CRSs, whether the mapping of the REG bundle to the REG by an existing mapping method (for example, the first method) has variation in the numbers of the REs corresponding to the NR PDCCH DMRSs on different REGs in the REG bundle is determined. If this situation does not occur, the first method may be used continuously; otherwise, mapping may be performed by the second method instead.

A relation between the distribution of the LTE CRSs and whether the numbers of the REs corresponding to the NR PDCCH DMRSs on different REGs in the REG bundle vary may be predetermined. For example, when the LTE CRSs are distributed on all the time-domain symbols in the CORESET, or when the LTE CRSs are distributed on none of all the time-domain symbols in the CORESET, there will be no situation where the numbers of the REs corresponding to the NR PDCCH DMRSs on different REGs in the REG bundle vary (that is, the numbers of REs corresponding to the NR PDCCH DMRSs on different REGs in the REG bundle are the same). When the LTE CRSs are distributed on some of the time-domain symbols in the CORESET, the numbers of the REs corresponding to the NR PDCCH DMRSs on different REGs in the REG bundle may vary.

Thus, the terminal may determine that mapping is performed by the second method according to the distribution of the LTE CRSs in the CORESET when the numbers of the REs corresponding to the NR PDCCH DMRSs on different REGs in the REG bundle vary. The terminal may determine that mapping is determined to be performed by the first method according to the distribution of the LTE CRSs in the CORESET when the numbers of the REs corresponding to the NR PDCCH DMRSs on different REGs in the REG bundle do not vary.

Thus, according to the example of the disclosure, the terminal may determine the mapping method of the REG bundle to the REG according to the distribution (for example, distribution of LTE CRS REs) of the LTE CRSs in the CORESET, such that variation in the numbers of the REs corresponding to the NR PDCCH DMRSs on different REGs in the REG bundle is avoided. Further, the REG bundle is determined in the CORESET according to the mapping method, and channel estimation is performed according to the REG bundle. Thus, the channel estimation can be performed under the condition that the numbers of the REs corresponding to the NR PDCCH DMRSs on the REGs in the REG bundle are the same, and accuracy of the channel estimation is guaranteed advantageously.

The example described above mainly describes a case where the LTE CRS conflicts with the NR PDCCH DMRS, the LTE CRS may also conflict with the NR PDCCH. In the case where the LTE CRS conflicts with the NR PDCCH, the NR PDCCH can be punctured according to the RE corresponding to the LTE CRS, or rate matching (RM) may be performed according to the RE corresponding to the LTE CRS.

FIG. 5 is a schematic flow diagram of another method for determining an REG bundle according to an example of the disclosure. As shown in FIG. 5, the step that a mapping method of an REG bundle to an REG is determined according to distribution of LTE CRSs in a CORESET includes S501 and previously described S102.

S501: it is determined that the mapping method includes the first method when the LTE CRSs are distributed on all the time-domain symbols in the CORESET.

In an example, when the LTE CRSs are distributed on all time-domain symbols in the CORESET, the LTE CRS is distributed on each REG, and the numbers of the REs corresponding to NR PDCCH DMRSs in conflict with the LTE CRSs on the REGs are the same, which is equivalent to reduction of the same number of REs for transmitting the NR PDCCH DMRSs on the REGs. Thus, the numbers of the REs corresponding to the NR PDCCH DMRSs on different REGs in the REG bundle are still the same, that is, the numbers of the REs corresponding to the NR PDCCH DMRSs on different REGs in the REG bundle cannot vary.

Thus, the mapping method in the related art, that is, the first method, may be used to map the REG bundle to the REG in the sequential order of the time domain first and the frequency domain. Based on that the same numbers of the REs corresponding to the NR PDCCH DMRSs on different REGs in the REG bundle, adjustment of the existing protocol can be reduced.

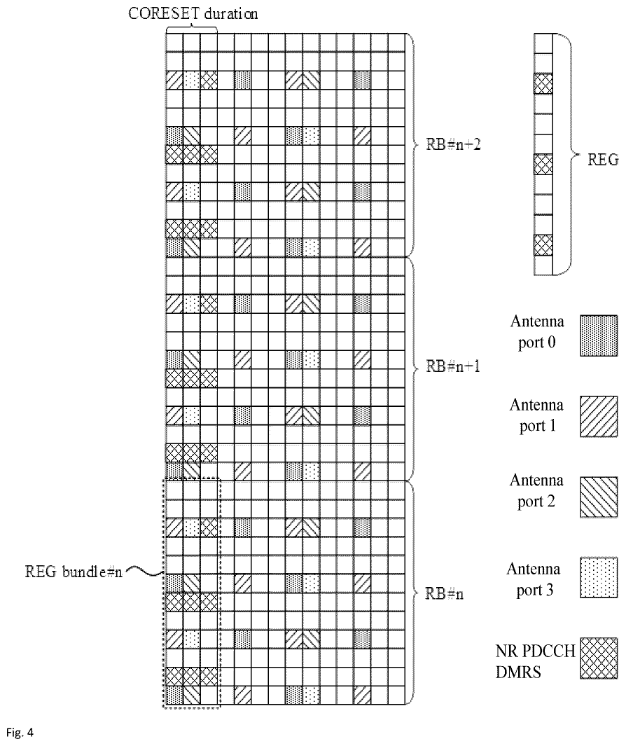

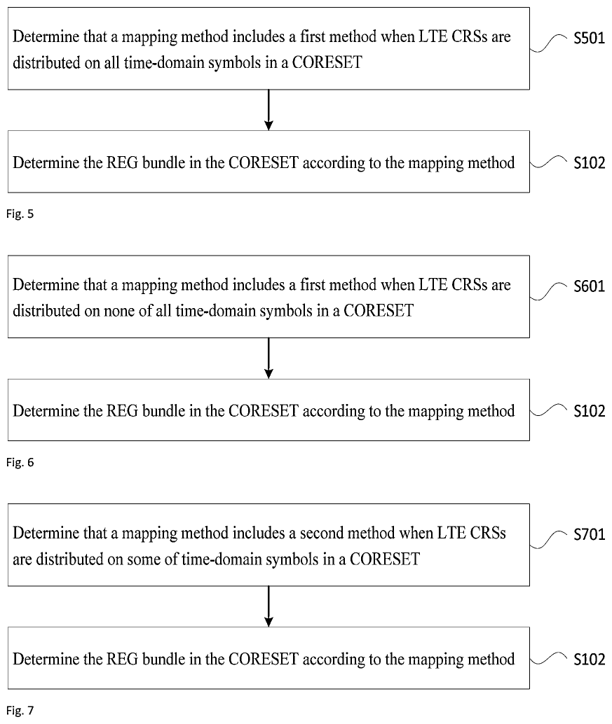

FIG. 6 is a schematic flow diagram of yet another method for determining an REG bundle according to an example of the disclosure. As shown in FIG. 6, the step that a mapping method of an REG bundle to an REG is determined according to distribution of LTE CRSs in a CORESET includes S601 and previously described S102.

S601: it is determined that the mapping method includes the first method when the LTE CRSs are distributed on none of all the time-domain symbols in the CORESET.

In an example, when the LTE CRSs are distributed on none of all the time-domain symbols in the CORESET, the LTE CRS is not distributed on each REG, and the numbers of the REs corresponding to original NR PDCCH DMRSs on the REGs are the same. Thus, the numbers of the REs corresponding to the NR PDCCH DMRSs on different REGs in the REG bundle are the same, and the numbers of the REs corresponding to the NR PDCCH DMRSs on different REGs in the REG bundle cannot vary.

Thus, the mapping method in the related art, that is, the first method, may be used to map the REG bundle to the REG in the sequential order of the time domain first and the frequency domain. Based on that the same numbers of the REs corresponding to the NR PDCCH DMRSs on different REGs in the REG bundle, adjustment of the existing protocol can be reduced.

FIG. 7 is a schematic flow diagram of yet another method for determining an REG bundle according to an example of the disclosure. As shown in FIG. 7, the step that a mapping method of an REG bundle to an REG is determined according to distribution of LTE CRSs in a CORESET includes S701 and previously described S102.

S701: it is determined that the mapping method includes the second method when the LTE CRSs are distributed on some of the time-domain symbols in the CORESET.

In an example, when the LTE CRSs are distributed on one part of the time-domain symbols in the CORESET, and the LTE CRSs are not distributed on the other part of the time-domain symbols, a number of REs for transmitting the NR PDCCH DMRSs is reduced on the REGs corresponding to the time-domain symbols on which the LTE CRSs are distributed, while the number of REs for transmitting the NR PDCCH DMRSs is not reduced on the REGs corresponding to the time-domain symbols on which the LTE CRSs are not distributed. Thus, the number of the REs corresponding to the NR PDCCH DMRSs on the REGs corresponding to the time-domain symbols on which the LTE CRSs are distributed vary from the number of the REs corresponding to the NR PDCCH DMRSs on the REGs corresponding to the time-domain symbols on which the LTE CRSs are not distributed in the REG bundle. That is, the numbers of the REs corresponding to the NR PDCCH DMRSs on different REGs in the REG bundle vary.

Thus, the second method may be used to map the REG bundle to the REG in the sequential order of the frequency domain and the time domain, guaranteeing that the numbers of the REs corresponding to the NR PDCCH DMRSs on different REGs in the REG bundle are the same, and further guaranteeing a desirable effect of channel estimation.

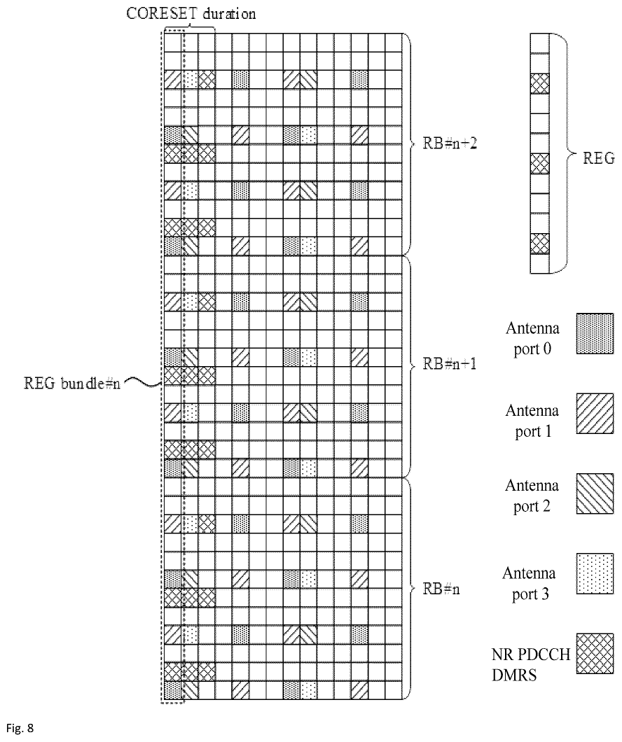

FIG. 8 is another schematic diagram of mapping an REG bundle to an REG according to an example of the disclosure.

In an example, when the LTE CRSs are distributed on some of the time-domain symbols in the CORESET, for example, in the example shown in FIG. 3, the LTE CRSs are distributed on first two symbols of the CORESET, and the LTE CRS is not distributed on a third symbol of the CORESET, then the REG bundle may be mapped to the REG in the sequential order of the frequency domain and the time domain.

As shown in FIG. 8, for example, a size of the REG bundle is 3, that is, one REG bundle is mapped to three REGs, and the CORESET corresponds to three RBs in the frequency domain.

The mapping of the REG bundle to the REG is performed in the sequential order of the frequency domain and the time domain. From a first symbol of RB #n, the REG bundle is mapped to the REG based on the frequency domain, then the REG bundle #n may be mapped to an REG corresponding to a first symbol of RB #n, an REG corresponding to a first symbol of RB #n+1 and an REG corresponding to a first symbol of RB #n+2.

By analogy, REG bundle #n+1 may be mapped to an REG corresponding to a second symbol of RB #n, an REG corresponding to a second symbol of RB #n+1 and an REG corresponding to a second symbol of RB #n+2. REG bundle #n+2 may be mapped to an REG corresponding to a third symbol of RB #n, an REG corresponding to a third symbol of RB #n+1 and an REG corresponding to a third symbol of RB #n+2. REG bundle #n+1 and REG bundle #n+2 are not marked in FIG. 8.

It can be seen that when the LTE CRSs are distributed on some of the time-domain symbols in the CORESET, the REG bundle is mapped to the REG in the sequential order of the frequency domain and the time domain, as shown in FIG. 8, one REG bundle includes three REGs, and the numbers of the Res corresponding to the NR PDCCH DMRSs on the REGs in the REG bundle are the same, thus guaranteeing a desirable effect of channel estimation.

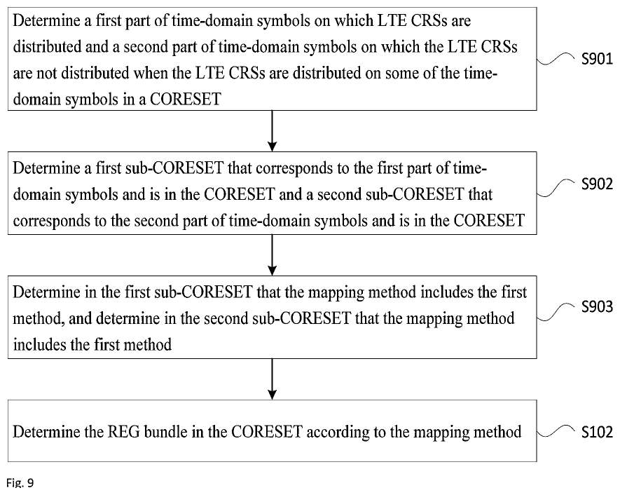

FIG. 9 is a schematic flow diagram of still another method for determining an REG bundle according to an example of the disclosure. As shown in FIG. 9, the step that a mapping method of an REG bundle to an REG is determined according to a distribution of LTE CRSs in a CORESET includes S901-S903 and previously described S102.

S901: a first part of time-domain symbols on which the LTE CRSs are distributed and a second part of time-domain symbols on which the LTE CRSs are not distributed are determined when the LTE CRSs are distributed on some of the time-domain symbols in the CORESET.

S902: a first sub-CORESET that corresponds to the first part of time-domain symbols and is in the CORESET and a second sub-CORESET that corresponds to the second part of time-domain symbols and is in the CORESET are determined.

S903: it is determined in the first sub-CORESET that the mapping method includes the first method, and determined in the second sub-CORESET that the mapping method includes the first method.

In an example, when the LTE CRSs are distributed on one part of the time-domain symbols in the CORESET, and the LTE CRSs are not distributed on the other part of the time-domain symbols, a number of REs for transmitting the NR PDCCH DMRSs is reduced on the REGs corresponding to the time-domain symbols on which the LTE CRSs are distributed, while the number of REs for transmitting the NR PDCCH DMRSs is not reduced on the REGs corresponding to the time-domain symbols on which the LTE CRSs are not distributed. Thus, the number of the REs corresponding to the NR PDCCH DMRSs on the REGs corresponding to the time-domain symbols on which the LTE CRSs are distributed vary from the number of the REs corresponding to the NR PDCCH DMRSs on the REGs corresponding to the time-domain symbols on which the LTE CRSs are not distributed in the REG bundle. That is, the numbers of the REs corresponding to the NR PDCCH DMRSs on different REGs in the REG bundle vary.

In this case, in addition to the second method for mapping, mapping may be performed by the first method. But, before mapping, some operations are needed to be performed on the CORESET.

In an example, at first, the first part of time-domain symbols on which the LTE CRSs are distributed and the second part of time-domain symbols on which the LTE CRSs are not distributed are determined when the LTE CRSs are distributed on some of the time-domain symbols in the CORESET.

Then, the first sub-CORESET that corresponds to the first part of time-domain symbols and is in the CORESET and the second sub-CORESET that corresponds to the second part of time-domain symbols and is in the CORESET are determined. Equivalently, the time-domain symbols on which the LTE CRSs are distributed are divided into one sub-CORESET in a resource corresponding to an original CORESET, and the time-domain symbols on which the LTE CRSs are not distributed are divided into another sub-CORESET in a resource corresponding to the original CORESET.

Finally, it is determined in the first sub-CORESET that the mapping method includes the first method, and determines in the second sub-CORESET that the mapping method includes the first method.

For the first sub-CORESET, since the LTE CRSs are distributed on all time-domain symbols in the first sub-CORESET, the LTE CRS is distributed on each REG, and the numbers of the REs corresponding to NR PDCCH DMRSs in conflict with the LTE CRSs on the REGs are the same, which is equivalent to reduction of the same number of REs for transmitting the NR PDCCH DMRSs on the REGs. Thus, the numbers of the REs corresponding to the NR PDCCH DMRSs on different REGs in the REG bundle are still the same, and in the first sub-CORESET, the numbers of the REs corresponding to the NR PDCCH DMRSs on different REGs in the REG bundle cannot vary.

In the second sub-CORESET, since the LTE CRSs are distributed on none of all the time-domain symbols in the second sub-CORESET, the LTE CRS is not distributed on each REG, and the numbers of the REs corresponding to original NR PDCCH DMRSs on the REGs are the same. Thus, the numbers of the REs corresponding to the NR PDCCH DMRSs on different REGs in the REG bundle are the same, and in the second sub-CORESET, the numbers of the REs corresponding to the NR PDCCH DMRSs on different REGs in the REG bundle cannot vary.

Thus, for the first sub-CORESET, the REG bundle may be mapped to the REG by the first method in the sequential order of the time domain and the frequency domain. For the second sub-CORESET, the REG bundle may also be mapped to the REG by the first method in the sequential order of the time domain and the frequency domain. Based on that the same numbers of the REs corresponding to the NR PDCCH DMRSs on different REGs in the REG bundle, adjustment of the existing protocol can be reduced.

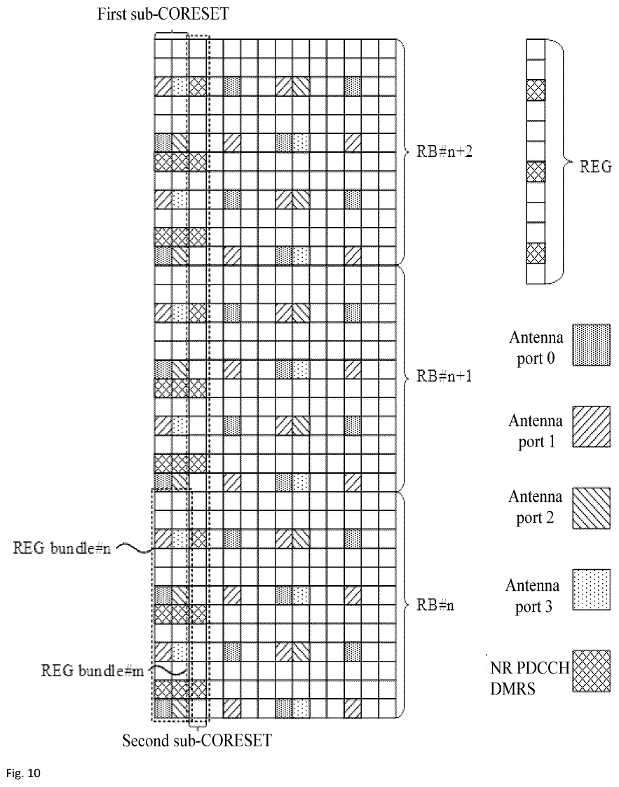

FIG. 10 is yet another schematic diagram of mapping an REG bundle to an REG according to an example of the disclosure.

In an example, when the LTE CRSs are distributed on the first part of the time-domain symbols and the LTE CRSs are not distributed on the second part of the time-domain symbols in the CORESET, for example, in the example shown in FIG. 3, the LTE CRSs are distributed on first two symbols of the CORESET, and the LTE CRS is not distributed on a third symbol of the CORESET, a resource corresponding to the CORESET where the first two symbols are located may be divided into the first sub-CORESET, and a resource corresponding to the CORESET where the third symbol is located may be divided into the second sub-CORESET as shown in FIG. 10.

Then, it is determined in the first sub-CORESET that the mapping method includes the first method, and determined in the second sub-CORESET that the mapping method includes the first method.

It should be noted that the size of the REG bundle corresponds to the CORESET, for example, specifically corresponds to CORESET duration. Thus, after the original CORESET is divided into the first sub-CORESET and the second sub-CORESET, a size of the REG bundle corresponding to the first sub-CORESET and a size of the REG bundle corresponding to the second sub-CORESET may be the same or not certainly.

For example, in the example shown in FIG. 10, the CORESET duration of the first sub-CORESET includes 2 symbols, and a size of a corresponding REG bundle size may be 2 accordingly, that is, one REG bundle is mapped to 2 REGs. The CORESET duration of the second sub-CORESET includes 1 symbol, and a size of a corresponding REG bundle size may be 3, that is, one REG bundle is mapped to 3 REGs.

Thus, in the first sub-CORESET, for mapping of the REG bundle to the REG according to the first method in the sequential order of the time domain and the frequency domain, the REG bundle may be mapped to an REG corresponding to a first symbol in RB #n of the first sub-CORESET at first, and then mapped to an REG corresponding to a second symbol of the first sub-CORESET. Since the size of the REG bundle in the first CORESET is 2, one REG bundle #n (including 2 REGs) may be mapped in RB #n of the first sub-CORESET. By analogy, one REG bundle #n+1 may be mapped in RB #n+1 of the first sub-CORESET, and one REG bundle #n+2 may be mapped in RB #n+2 of the first sub-CORESET.

In the second CORESET, for mapping of the REG bundle to the REG according to the first method in the sequential order of the time domain and the frequency domain, the REG bundle may be mapped to an REG corresponding to a first symbol in RB #n of the second sub-CORESET at first, and then mapped to an REG corresponding to a second symbol of the second sub-CORESET. Since there is merely one symbol in the second sub-CORESET and the size of the REG bundle in the second sub-CORESET is 3, one REG bundle #m (including 3 REGs) may be mapped to first symbols of RB #n, RB #n+1 and RB #n+2 in the second sub-CORESET.

It can be seen that when the LTE CRSs are distributed on some of time-domain symbols in the CORESET, the original CORESET is divided, and the mapping of the REG bundle to REG is performed in the first sub-CORESET and the second sub-CORESET in the sequential order of the time domain and the frequency domain. For example, as shown in FIG. 10, the numbers of the REs corresponding to the NR PDCCH DMRSs on the REGs in the REG bundle in the first sub-CORESET are the same, and the numbers of the REs corresponding to the NR PDCCH DMRSs on the REGs in the REG bundle in the second sub-CORESET are also the same, thus guaranteeing a desirable effect of channel estimation.

In an example, the step that the REG bundle is determined in the CORESET according to the mapping method includes: a first REG bundle is determined on an REG in the first sub-CORESET according to the first method, and a second REG bundle is determined on an REG in the second sub-CORESET according to the first method.

Since the original CORESET is divided into the first sub-CORESET and the second sub-CORESET, that is, two CORESETs are formed equivalently, the terminal needs to determine the REG bundles in the two sub-CORESETs respectively. Specifically, the first REG bundle may be determined on the REG in the first sub-CORESET according to the first method, and the second REG bundle may be determined on the REG in the second sub-CORESET according to the first method.

It should be noted that a division method of the original CORESET and the size of the REG bundle corresponding to each sub-CORESET after division may be determined in advance based on a protocol for the terminal and the network-side device, or may be determined by the network-side device as required, and then indicated to the terminal, for example, through system information and paging signaling.

FIG. 11 is a schematic flow diagram of a method for mapping an REG bundle according to an example of the disclosure. The method for mapping an REG bundle shown in this example may be performed by the network-side device. The network-side device includes, but is not limited to, a base station in a communication system such as a 4G base station, a 5G base station and a 6G base station. The base station may communicate with the terminal that serves as user equipment. The terminal includes, but is not limited to, a communication apparatus such as a mobile phone, a portable android device, a wearable device, a sensor and an Internet of things device.

As shown in FIG. 11, the method for mapping an REG bundle may include S1101 and S1102.

S1101: a mapping method of an REG bundle to an REG is determined according to a distribution of LTE CRSs in a CORESET.

S1102: the REG bundle is mapped in the CORESET according to the mapping method.

In an example, the mapping method includes at least one of the following: a first method: the REG bundle is mapped to the REG in a sequential order of a time domain and a frequency domain; or a second method: the REG bundle is mapped to the REG in a sequential order of a frequency domain and a time domain.

In an example, the distribution of the LTE CRSs includes at least one of the following: the LTE CRSs are distributed on all time-domain symbols in the CORESET; the LTE CRSs are distributed on none of all time-domain symbols in the CORESET; or the LTE CRSs are distributed on one part of time-domain symbols in the CORESET (the LTE CRSs are not distributed on the other part of time-domain symbols).

In an example, based on the distribution of the LTE CRSs, whether the mapping of the REG bundle to the REG by an existing mapping method (for example, the first method) has variation in the numbers of the REs corresponding to the NR PDCCH DMRSs on different REGs in the REG bundle is determined. If this situation does not occur, the first method may be used continuously; otherwise, mapping may be performed by the second method instead.

A relation between the distribution of the LTE CRSs and whether the numbers of the REs corresponding to the NR PDCCH DMRSs on different REGs in the REG bundle vary may be predetermined. For example, when the LTE CRSs are distributed on all the time-domain symbols in the CORESET, or when the LTE CRSs are distributed on none of all the time-domain symbols in the CORESET, there will be no situation where the numbers of the REs corresponding to the NR PDCCH DMRSs on different REGs in the REG bundle vary (that is, the numbers of REs corresponding to the NR PDCCH DMRSs on different REGs in the REG bundle are the same). When the LTE CRSs are distributed on some of the time-domain symbols in the CORESET, the numbers of the REs corresponding to the NR PDCCH DMRSs on different REGs in the REG bundle may vary.

Thus, the network-side device determines that mapping is performed by the second method according to the distribution of the LTE CRSs in the CORESET when the numbers of the REs corresponding to the NR PDCCH DMRSs on different REGs in the REG bundle vary. The network-side device determines that mapping is determined to be performed by the first method according to the distribution of the LTE CRSs in the CORESET when the numbers of the REs corresponding to the NR PDCCH DMRSs on different REGs in the REG bundle do not vary.

Thus, according to the example of the disclosure, the network-side device may determine the mapping method of the REG bundle to the REG according to the distribution of the LTE CRSs (specifically, corresponding REs) in the CORESET, such that variation in a number of REs corresponding to NR PDCCH DMRSs on different REGs in the REG bundle is avoided. Further, the REG bundle is mapped in the CORESET according to the mapping method, and channel estimation is performed according to the REG bundle. Thus, the channel estimation can be performed under the condition that the numbers of the REs corresponding to the NR PDCCH DMRSs on the REGs in the REG bundle are the same, and accuracy of the channel estimation is guaranteed advantageously.

The example described above mainly describes a case where the LTE CRS conflicts with the NR PDCCH DMRS, the LTE CRS may also conflict with the NR PDCCH. In the case where the LTE CRS conflicts with the NR PDCCH, the NR PDCCH can be punctured according to the RE corresponding to the LTE CRS, or rate matching may be performed according to the RE corresponding to the LTE CRS.

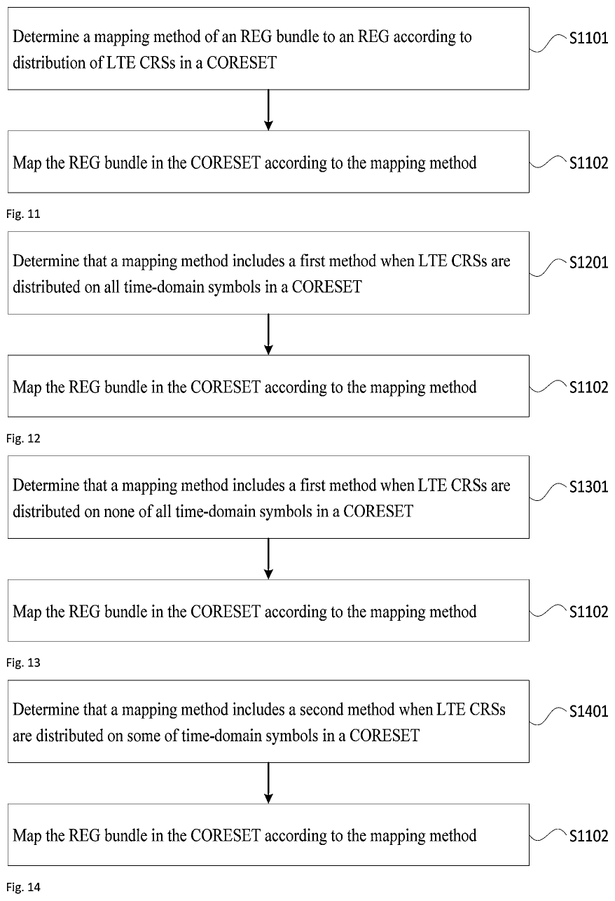

FIG. 12 is a schematic flow diagram of another method for mapping an REG bundle according to an example of the disclosure. As shown in FIG. 12, the step that a mapping method of an REG bundle to an REG is determined according to a distribution of LTE CRSs in a CORESET includes S1201 and previously described S1102.

S1201: it is determined that the mapping method includes the first method when the LTE CRSs are distributed on all the time-domain symbols in the CORESET.

In an example, when the LTE CRSs are distributed on all time-domain symbols in the CORESET, the LTE CRS is distributed on each REG, and the numbers of the REs corresponding to NR PDCCH DMRSs in conflict with the LTE CRSs on the REGs are the same, which is equivalent to reduction of the same number of REs for transmitting the NR PDCCH DMRSs on the REGs. Thus, the numbers of the REs corresponding to the NR PDCCH DMRSs on different REGs in the REG bundle are still the same, that is, the numbers of the REs corresponding to the NR PDCCH DMRSs on different REGs in the REG bundle cannot vary.

Thus, the mapping method in the related art, that is, the first method, may be used to map the REG bundle to the REG in the sequential order of the time domain first and the frequency domain. Based on that the same numbers of the REs corresponding to the NR PDCCH DMRSs on different REGs in the REG bundle, adjustment of the existing protocol can be reduced.

FIG. 13 is a schematic flow diagram of yet another method for mapping an REG bundle according to an example of the disclosure. As shown in FIG. 13, the step that a mapping method of an REG bundle to an REG is determined according to a distribution of LTE CRSs in a CORESET includes S1301 and previously described S1102.

S1301: it is determined that the mapping method includes the first method when the LTE CRSs are distributed on none of all the time-domain symbols in the CORESET.

In an example, when the LTE CRSs are distributed on none of all the time-domain symbols in the CORESET, the LTE CRS is not distributed on each REG, and the numbers of the REs corresponding to original NR PDCCH DMRSs on the REGs are the same. Thus, the numbers of the REs corresponding to the NR PDCCH DMRSs on different REGs in the REG bundle are the same, and the numbers of the REs corresponding to the NR PDCCH DMRSs on different REGs in the REG bundle cannot vary.

Thus, the mapping method in the related art, that is, the first method, may be used to map the REG bundle to the REG in the sequential order of the time domain first and the frequency domain. Based on that the same numbers of the REs corresponding to the NR PDCCH DMRSs on different REGs in the REG bundle, adjustment of the existing protocol can be reduced.

FIG. 14 is a schematic flow diagram of yet another method for mapping an REG bundle according to an example of the disclosure. As shown in FIG. 14, the step that a mapping method of an REG bundle to an REG is determined according to distribution of LTE CRSs in a CORESET includes S1401 and previously described S1102.

S1401: it is determined that the mapping method includes the second method when the LTE CRSs are distributed on some of the time-domain symbols in the CORESET.

In an example, when the LTE CRSs are distributed on one part of the time-domain symbols in the CORESET, and the LTE CRSs are not distributed on the other part of the time-domain symbols, a number of REs for transmitting the NR PDCCH DMRSs is reduced on the REGs corresponding to the time-domain symbols on which the LTE CRSs are distributed, while the number of REs for transmitting the NR PDCCH DMRSs is not reduced on the REGs corresponding to the time-domain symbols on which the LTE CRSs are not distributed. Thus, the number of the REs corresponding to the NR PDCCH DMRSs on the REGs corresponding to the time-domain symbols on which the LTE CRSs are distributed vary from the number of the REs corresponding to the NR PDCCH DMRSs on the REGs corresponding to the time-domain symbols on which the LTE CRSs are not distributed in the REG bundle. That is, the numbers of the REs corresponding to the NR PDCCH DMRSs on different REGs in the REG bundle vary.

Thus, the second method may be used to map the REG bundle to the REG in the sequential order of the frequency domain and the time domain, guaranteeing that the numbers of the REs corresponding to the NR PDCCH DMRSs on different REGs in the REG bundle are the same, and further guaranteeing a desirable effect of channel estimation.

FIG. 15 is a schematic flow diagram of still another method for mapping an REG bundle according to an example of the disclosure. As shown in FIG. 15, the step that a mapping method of an REG bundle to an REG is determined according to distribution of LTE CRSs in a CORESET includes S1501-S1503 and previously described S1102.

S1501: a first part of time-domain symbols on which the LTE CRSs are distributed and a second part of time-domain symbols on which the LTE CRSs are not distributed are determined when the LTE CRSs are distributed on some of the time-domain symbols in the CORESET.

S1502: a first sub-CORESET that corresponds to the first part of time-domain symbols and is in the CORESET and a second sub-CORESET that corresponds to the second part of time-domain symbols and is in the CORESET are determined.

S1503: it is determined in the first sub-CORESET that the mapping method includes the first method, and determined in the second sub-CORESET that the mapping method includes the first method.

In an example, when the LTE CRSs are distributed on one part of the time-domain symbols in the CORESET, and the LTE CRSs are not distributed on the other part of the time-domain symbols, a number of REs for transmitting the NR PDCCH DMRSs is reduced on the REGs corresponding to the time-domain symbols on which the LTE CRSs are distributed, while the number of REs for transmitting the NR PDCCH DMRSs is not reduced on the REGs corresponding to the time-domain symbols on which the LTE CRSs are not distributed. Thus, the number of the REs corresponding to the NR PDCCH DMRSs on the REGs corresponding to the time-domain symbols on which the LTE CRSs are distributed vary from the number of the REs corresponding to the NR PDCCH DMRSs on the REGs corresponding to the time-domain symbols on which the LTE CRSs are not distributed in the REG bundle. That is, the numbers of the REs corresponding to the NR PDCCH DMRSs on different REGs in the REG bundle vary.

In this case, in addition to the second method for mapping, mapping may be performed by the first method. But, before mapping, some operations are needed to be performed on the CORESET.

In an example, at first, the first part of time-domain symbols on which the LTE CRSs are distributed and the second part of time-domain symbols on which the LTE CRSs are not distributed are determined when the LTE CRSs are distributed on some of the time-domain symbols in the CORESET.

Then, the first sub-CORESET that corresponds to the first part of time-domain symbols and is in the CORESET and the second sub-CORESET that corresponds to the second part of time-domain symbols and is in the CORESET are determined. Equivalently, the time-domain symbols on which the LTE CRSs are distributed are divided into one sub-CORESET in a resource corresponding to an original CORESET, and the time-domain symbols on which the LTE CRSs are not distributed are divided into another sub-CORESET in a resource corresponding to the original CORESET.

Finally, it is determined in the first sub-CORESET that the mapping method includes the first method, and determines in the second sub-CORESET that the mapping method includes the first method.

For the first sub-CORESET, since the LTE CRSs are distributed on all time-domain symbols in the first sub-CORESET, the LTE CRS is distributed on each REG, and the numbers of the REs corresponding to NR PDCCH DMRSs in conflict with the LTE CRSs on the REGs are the same, which is equivalent to reduction of the same number of REs for transmitting the NR PDCCH DMRSs on the REGs. Thus, the numbers of the REs corresponding to the NR PDCCH DMRSs on different REGs in the REG bundle are still the same, and in the first sub-CORESET, the numbers of the REs corresponding to the NR PDCCH DMRSs on different REGs in the REG bundle cannot vary.

In the second sub-CORESET, since the LTE CRSs are distributed on none of all the time-domain symbols in the second sub-CORESET, the LTE CRS is not distributed on each REG, and the numbers of the REs corresponding to original NR PDCCH DMRSs on the REGs are the same. Thus, the numbers of the REs corresponding to the NR PDCCH DMRSs on different REGs in the REG bundle are the same, and in the second sub-CORESET, the numbers of the REs corresponding to the NR PDCCH DMRSs on different REGs in the REG bundle cannot vary.

Thus, for the first sub-CORESET, the REG bundle may be mapped to the REG by the first method in the sequential order of the time domain and the frequency domain. For the second sub-CORESET, the REG bundle may also be mapped to the REG by the first method in the sequential order of the time domain and the frequency domain. Based on that the same numbers of the REs corresponding to the NR PDCCH DMRSs on different REGs in the REG bundle, adjustment of the existing protocol can be reduced.

In an example, the step that the REG bundle is determined in the CORESET according to the mapping method includes: a first REG bundle on an REG in the first sub-CORESET is mapped according to the first method; and a second REG bundle on an REG in the second sub-CORESET is mapped according to the first method.

Since the original CORESET is divided into the first sub-CORESET and the second sub-CORESET, that is, two CORESETs are formed equivalently, the terminal needs to determine the REG bundles in the two sub-CORESETs respectively. Specifically, the first REG bundle may be determined on the REG in the first sub-CORESET according to the first method, and the second REG bundle may be determined on the REG in the second sub-CORESET according to the first method.

It should be noted that a division method of the original CORESET and the size of the REG bundle corresponding to each sub-CORESET after division may be determined in advance based on a protocol for the terminal and the network-side device, or may be determined by the network-side device as required, and then indicated to the terminal, for example, through system information and paging signaling.

Corresponding to the foregoing examples of the method for determining an REG bundle and the method for mapping an REG bundle, the disclosure further provides examples of the apparatus for determining an REG bundle and the apparatus for mapping an REG bundle.

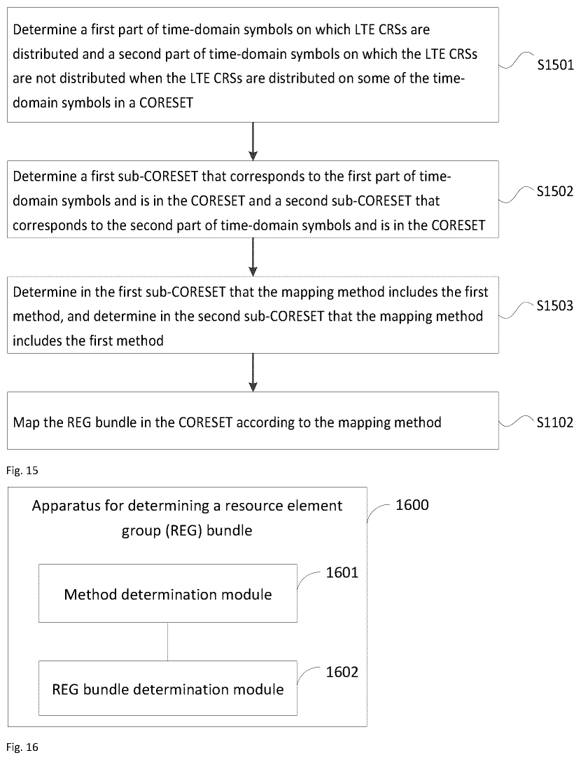

FIG. 16 is a schematic block diagram of an apparatus for determining an REG bundle 1600 according to an example of the disclosure. The apparatus for determining an REG bundle 1600 shown in this example may be performed by a terminal. The terminal may be in communication with a network-side device. The terminal includes, but is not limited to, communication apparatuses such as a mobile phone, a portable android device, a wearable device, a sensor, and an Internet of things device. The network-side device includes, but is not limited to, a base station and a core network in communication systems, such as a fourth generation (4G) communication system, a 5G communication system and a 6G communication system.

As shown in FIG. 16, the apparatus for determining an REG bundle 1600 may include a method determination module 1601 and an REG bundle determination module 1602.

The method determination module 1601 configured to determine a mapping method of an REG bundle to an REG according to distribution of LTE CRSs in a CORESET.

The REG bundle determination module 1602 configured to determine the REG bundle in the CORESET according to the mapping method.

In an example, the mapping method includes at least one of the following: a first method: the REG bundle is mapped to the REG in a sequential order of a time domain and a frequency domain; or a second method: the REG bundle is mapped to the REG in a sequential order of a frequency domain and a time domain.

In an example, the distribution of the LTE CRSs includes at least one of the following: the LTE CRSs are distributed on all time-domain symbols in the CORESET; the LTE CRSs are distributed on none of all time-domain symbols in the CORESET; or the LTE CRSs are distributed on some of time-domain symbols in the CORESET.

In an example, the method determination module 1601 is configured to determine that the mapping method includes the first method when the LTE CRSs are distributed on all the time-domain symbols in the CORESET.

In an example, the method determination module 1601 is configured to determine that the mapping method includes the first method when the LTE CRSs are distributed on none of all the time-domain symbols in the CORESET.

In an example, the method determination module 1601 is configured to determine that the mapping method includes the second method when the LTE CRSs are distributed on some of the time-domain symbols in the CORESET.

In an example, the method determination module 1601 is configured to determine a first part of time-domain symbols on which the LTE CRSs are distributed and a second part of time-domain symbols on which the LTE CRSs are not distributed when the LTE CRSs are distributed on some of the time-domain symbols in the CORESET; determine a first sub-CORESET that corresponds to the first part of time-domain symbols and is in the CORESET and a second sub-CORESET that corresponds to the second part of time-domain symbols and is in the CORESET; and determine in the first sub-CORESET that the mapping method includes the first method, and determine in the second sub-CORESET that the mapping method includes the first method.

In an example, the REG bundle determination module 1602 is configured to determine a first REG bundle on an REG in the first sub-CORESET according to the first method; and determine a second REG bundle on an REG in the second sub-CORESET according to the first method.

FIG. 17 is a schematic block diagram of an apparatus for mapping an REG bundle 1700 according to an example of the disclosure. The apparatus for mapping an REG bundle 1700 shown in this example may be performed by the network-side device. The network-side device includes, but is not limited to, a base station in a communication system such as a 4G base station, a 5G base station and a 6G base station. The base station may communicate with the terminal that serves as user equipment. The terminal includes, but is not limited to, a communication apparatus such as a mobile phone, a portable android device, a wearable device, a sensor and an Internet of things device.

As shown in FIG. 17, the apparatus for mapping an REG bundle includes a method determination module 1701, and an REG bundle mapping module 1702.

The method determination module 1701 configured to determine a mapping method of an REG bundle to an REG according to distribution of LTE CRSs in a CORESET.

The REG bundle mapping module 1702 configured to map the REG bundle in the CORESET according to the mapping method.

In an example, the mapping method includes at least one of the following: a first method: the REG bundle is mapped to the REG in a sequential order of a time domain and a frequency domain; or a second method: the REG bundle is mapped to the REG in a sequential order of a frequency domain and a time domain.

In an example, the distribution of the LTE CRSs includes at least one of the following: the LTE CRSs are distributed on all time-domain symbols in the CORESET; the LTE CRSs are distributed on none of all time-domain symbols in the CORESET; or the LTE CRSs are distributed on some of time-domain symbols in the CORESET.

In an example, the method determination module 1701 is configured to determine that the mapping method includes the first method when the LTE CRSs are distributed on all the time-domain symbols in the CORESET.

In an example, the method determination module 1701 is configured to determine that the mapping method includes the first method when the LTE CRSs are distributed on none of all the time-domain symbols in the CORESET.

In an example, the method determination module 1701 is configured to determine that the mapping method includes the second method when the LTE CRSs are distributed on some of the time-domain symbols in the CORESET.

In an example, the method determination module 1701 is configured to determine a first part of time-domain symbols on which the LTE CRSs are distributed and a second part of time-domain symbols on which the LTE CRSs are not distributed when the LTE CRSs are distributed on some of the time-domain symbols in the CORESET; determine a first sub-CORESET that corresponds to the first part of time-domain symbols and is in the CORESET and a second sub-CORESET that corresponds to the second part of time-domain symbols and is in the CORESET; and determine in the first sub-CORESET that the mapping method includes the first method, and determine in the second sub-CORESET that the mapping method includes the first method.

In an example, the REG bundle mapping module 1702 is configured to map a first REG bundle on an REG in the first sub-CORESET according to the first method; and map a second REG bundle on an REG in the second sub-CORESET according to the first method.

With respect to the apparatus in the example described above, specific methods in which the modules execute operations have been described in detail in the relevant method examples, and will not be described in detail here.

As for the apparatus example, since this example basically corresponds to the method example, reference can be made to partial description of the method example for relevant contents. The apparatus example described above is merely illustrative, the modules described as separated components can be physically separated or not, and the components displayed as the modules can be physical modules or not, that is, the components can be located in one place or distributed to a plurality of network modules. Some or all of modules can be selected according to actual requirements to achieve the objective of the solution of the example. What is described above can be understood and implemented by those skilled in the art without creative efforts.

The example of the disclosure further provides a communication apparatus. The communication apparatus includes a processor; and a memory configured to store a computer program. The computer program implements the method for determining an REG bundle of any example described above when executed by the processor.

The example of the disclosure further provides a communication apparatus. The communication apparatus includes: a processor; and a memory configured to store a computer program. The computer program implements the method for mapping an REG bundle of any example described above when executed by the processor.

The example of the disclosure further provides a non-transitory computer-readable storage medium. The computer-readable storage medium is configured to store a computer program. The computer program implements steps of the method for determining an REG bundle of any example described above when executed by a processor.

The example of the disclosure further provides a non-transitory computer-readable storage medium. The computer-readable storage medium is configured to store a computer program. The computer program implements steps of the method for mapping an REG bundle of any example described above when executed by a processor.

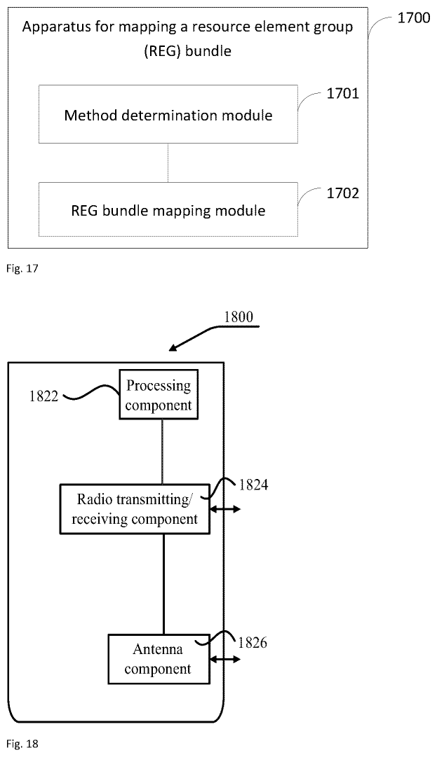

As shown in FIG. 18, FIG. 18 is a schematic block diagram of an apparatus 1800 for mapping an REG bundle according to an example of the disclosure. The apparatus 1800 may be provided as a base station. With reference to FIG. 18, the apparatus 1800 includes a processing component 1822, a wireless transmitting/receiving component 1824, an antenna component 1826, and a signal processing portion specific to a wireless interface. The processing component 1822 may further include one or more processors. One of the processors of the processing component 1822 may be configured to implement the method for mapping an REG bundle of any example described above.

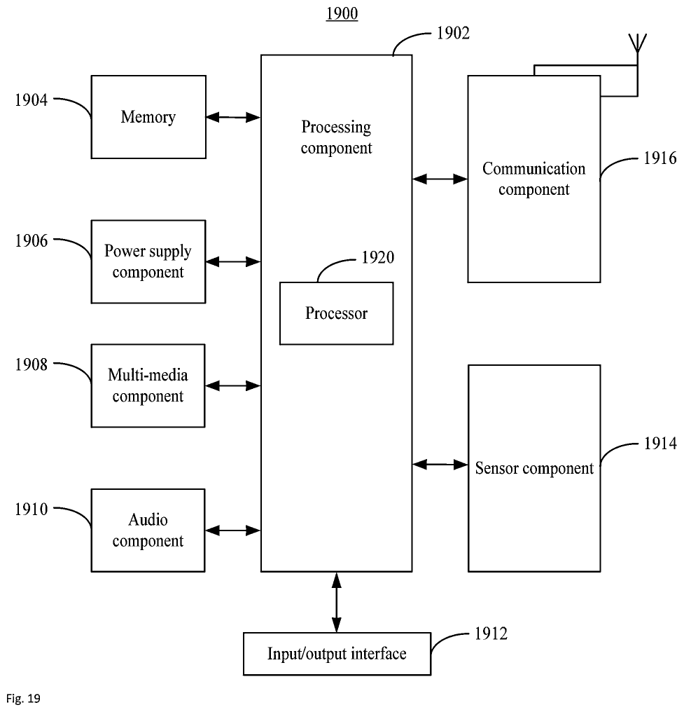

FIG. 19 is a schematic block diagram of an apparatus 1900 for determining an REG bundle according to an example of the disclosure. For example, the apparatus 1900 may be a mobile phone, a computer, a digital broadcasting terminal, a message receiving and transmitting device, a game console, a portable android device, a medical device, a fitness device, a personal digital assistant, etc.

With reference to FIG. 19, the apparatus 1900 may include one or more of components as follows: a processing component 1902, a memory 1904, a power supply component 1906, a multi-media component 1908, an audio component 1910, an input/output (1/O) interface 1912, a sensor component 1914 and a communication component 1916.

The processing component 1902 generally controls overall operations of the apparatus 1900, such as operations associated with display, telephone call, data communication, a camera operation and a recording operation. The processing component 1902 may include one or more processors 1920 for executing an instruction, and completing all or some of the steps of the method for determining an REG bundle described above. In addition, the processing component 1902 may include one or more modules to facilitate interaction between the processing component 1902 and other components. For example, the processing component 1902 may include a multimedia module to facilitate interaction between the multi-media component 1908 and the processing component 1902.

The memory 1904 is configured to store various types of data to support the operation of the apparatus 1900. Instances of such data include instructions configured for any application or method operating on the apparatus 1900, such as contact data, phonebook data, messages, pictures and videos. The memory 1904 may be implemented by any type of volatile or non-volatile storage devices or their combinations, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk and an optical disk.

The power supply component 1906 energizes various components of the apparatus 1900. The power supply component 1906 may include a power management system, one or more power supplies, and other assemblies associated with power generation, management, and distribution for the apparatus 1900.

The multi-media component 1908 includes a screen providing an output interface between the apparatus 1900 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touch, swipe, and gestures on the touch panel. The touch sensors may not merely sense a boundary of a touch or swipe action, but also measure time of duration and a pressure associated with the touch or swipe operation. In some examples, the multi-media component 1908 includes a front-facing camera and/or a rear-facing camera. When the apparatus 1900 is in an operating mode, such as a photographing mode or a video mode, the front-facing camera and/or the rear-facing camera may receive external multi-media data. Each of the front-facing camera and the rear-facing camera may be a constant optical lens system or have a variable focal length and optical zoom capacity.

The audio component 1910 is configured to output and/or input an audio signal. For example, the audio component 1910 includes a microphone (MIC). When the apparatus 1900 is in an operating mode, such as a call mode, a recording mode or a voice recognition mode, the microphone is configured to receive an external audio signal. The received audio signal may be further stored in the memory 1904 or sent via the communication component 1916. In some examples, the audio component 1910 further includes a speaker for outputting audio signals.

The I/O interface 1912 provides an interface between the processing component 1902 and peripheral interface modules, such as a keyboard, a click wheel and a button. These buttons may include, but are not limited to, a home button, a volume button, a start button and a lock button.

The sensor component 1914 includes one or more sensors configured to provide state assessment in various aspects for the apparatus 1900. For example, the sensor component 1914 may detect a startup/shutdown state of the apparatus 1900, and relative positioning of components, for example, a display and a keypad of the apparatus 1900. The sensor component 1914 may further detect a position change of the apparatus 1900 or a component of the apparatus 1900, presence or absence of a touch between the user and the apparatus 1900, an orientation or acceleration/deceleration of the apparatus 1900, and a temperature change of the apparatus 1900. The sensor component 1914 may include a proximity sensor configured to detect the presence of a nearby object in the absence of any physical touch. The sensor component 1914 may further include an optical sensor, such as a complementary metal-oxide-semiconductor transistor (CMOS) or charge-coupled device (CCD) image sensor for use in imaging applications. In some examples, this sensor component 1914 may further include an acceleration sensor, a gyroscopic sensor, a magnetic sensor, a pressure sensor or a temperature sensor.

The communication component 1916 is configured to facilitate wired or wireless communication between the apparatus 1900 and other devices. The apparatus 1900 may access a wireless network based on a communication standard, such as Wi-Fi, 2G, 3G, 4G LTE, 5G NR or their combinations. In an illustrative example, the communication component 1916 receives a broadcast signal or broadcast related information from an external broadcast management system via a broadcast channel. In an illustrative example, the communication component 1916 further includes a near field communication (NFC) module to promote short-range communication. For example, the NFC module may be implemented on the basis of a radio frequency identification (RFID) technology, an infrared data association (IrDA) technology, an ultra wideband (UWB) technology, a Bluetooth (BT) technology and other technologies.

In an illustrative example, the apparatus 1900 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components for executing the method for determining an REG bundle described above.

In an illustrative example, a non-transitory computer-readable storage medium including an instruction is further provided, such as the memory 1904 including an instruction. The instruction may be executed by the processor 1920 of the apparatus 1900 for implementing the method for determining an REG bundle described above. For example, the non-transitory computer-readable storage medium may be a read only memory (ROM), a random access memory (RAM), a CD-ROM, a magnetic tape, a floppy disc, an optical data storage device, etc.

Those skilled in the art could easily conceive of other implementation solutions of the disclosure with consideration of the description and the disclosure disclosed here. The disclosure intends to cover any variation, use or adaptive change of the disclosure, which follows general principles of the disclosure and includes common general knowledge or conventional technical means in the technical field not disclosed in the disclosure. The description and the examples are merely considered illustrative, and a true scope and spirit of the disclosure are indicated by the following claims.

It should be understood that the disclosure is not limited to precise structures described above and shown in the accompanying drawings, and various modifications and changes can be made without departing from the scope of the disclosure. The scope of the disclosure is limited by the appended claims merely.

It should be noted that in the description, relational terms such as first and second are merely used to distinguish one entity or one operation from another entity or another operation, and do not necessarily require or imply any such actual relation or order among these entities or operations. In addition, the terms “comprise”, “include” or their other vibrations intend to cover non-exclusive inclusion, such that a process, a method, an article or a device including a series of elements not only includes those elements, but includes other elements not listed clearly, or further includes elements inherent to such a process, method, article or device. In the case of no more limitation, an element limited by the phrase “comprise a . . . ” or “include a . . . ” does not exclude another same element existing in a process, method, article or device including the element.

The method and apparatus according to the examples of the disclosure are described in detail above. Specific instances are used here to explain the principles and embodiments of the disclosure. The description above of the examples merely intends to help understand the method of the disclosure and its core ideas. Modifications can be made by those skilled in the art to specific embodiments and the application scope in accordance with the ideas of the disclosure. To sum up, the contents of the description should not be understood as limitation to the disclosure.

1. A method for determining a resource element group (REG) bundle, wherein the method is performed by a terminal, and comprises:
determining a mapping method of the REG bundle to an REG according to distribution of long term evolution cell-specific reference signals (LTE CRSs) in a control resource set (CORESET); and
determining the REG bundle in the CORESET according to the mapping method.

2. The method according to claim 1, wherein the mapping method comprises at least one of the following:
a first method: mapping the REG bundle to the REG in a sequential order of a time domain and a frequency domain; or
a second method: mapping the REG bundle to the REG in a sequential order of a frequency domain and a time domain.

3. The method according to claim 2, wherein the distribution of the LTE CRSs comprises at least one of the following:
the LTE CRSs are distributed on all time-domain symbols in the CORESET;
the LTE CRSs are distributed on none of all time-domain symbols in the CORESET; or
the LTE CRSs are distributed on some of time-domain symbols in the CORESET.

4. The method according to claim 3, wherein the determining the mapping method of the REG bundle to the REG according to distribution of LTE CRSs in the CORESET comprises:
determining that the mapping method comprises the first method on a condition that the LTE CRSs are distributed on all the time-domain symbols in the CORESET.

5. The method according to claim 3, wherein the determining the mapping method of the REG bundle to the REG according to distribution of LTE CRSs in the CORESET comprises:
determining that the mapping method comprises the first method on a condition that the LTE CRSs are distributed on none of all the time-domain symbols in the CORESET.

6. The method according to claim 3, wherein the determining the mapping method of the REG bundle to the REG according to distribution of LTE CRSs in the CORESET comprises:
determining that the mapping method comprises the second method on a condition that the LTE CRSs are distributed on some of the time-domain symbols in the CORESET.

7. The method according to claim 3, wherein the determining the mapping method of the REG bundle to the REG according to distribution of LTE CRSs in the CORESET comprises:
determining a first part of time-domain symbols on which the LTE CRSs are distributed and a second part of time-domain symbols on which the LTE CRSs are not distributed on a condition that the LTE CRSs are distributed on some of the time-domain symbols in the CORESET;
determining a first sub-CORESET that corresponds to the first part of time-domain symbols and is in the CORESET and a second sub-CORESET that corresponds to the second part of time-domain symbols and is in the CORESET; and
determining in the first sub-CORESET that the mapping method comprises the first method, and determining in the second sub-CORESET that the mapping method comprises the first method.

8. The method according to claim 7, wherein the determining the REG bundle in the CORESET according to the mapping method comprises:
determining a first REG bundle on an REG in the first sub-CORESET according to the first method; and
determining a second REG bundle on an REG in the second sub-CORESET according to the first method.

9. A method for mapping a resource element group (REG) bundle, wherein the method is performed by a network-side device, and comprises:
determining a mapping method of the REG bundle to an REG according to distribution of long term evolution cell-specific reference signals (LTE CRSs) in a control resource set (CORESET); and
mapping the REG bundle in the CORESET according to the mapping method.

10. The method according to claim 9, wherein the mapping method comprises at least one of the following:
a first method: mapping the REG bundle to the REG in a sequential order of a time domain and a frequency domain; or
a second method: mapping the REG bundle to the REG in a sequential order of a frequency domain and a time domain.

11. The method according to claim 10, wherein the distribution of the LTE CRSs comprises at least one of the following:
the LTE CRSs are distributed on all time-domain symbols in the CORESET;
the LTE CRSs are distributed on none of all time-domain symbols in the CORESET; or
the LTE CRSs are distributed on some of time-domain symbols in the CORESET.

12. The method according to claim 11, wherein the determining the mapping method of the REG bundle to the REG according to distribution of LTE CRSs in the CORESET comprises:
determining that the mapping method comprises the first method on a condition that the LTE CRSs are distributed on all the time-domain symbols in the CORESET.

13. The method according to claim 11, wherein the determining the mapping method of the REG bundle to the REG according to distribution of LTE CRSs in the CORESET comprises:
determining that the mapping method comprises the first method on a condition that the LTE CRSs are distributed on none of all the time-domain symbols in the CORESET.

14. The method according to claim 11, wherein the determining the mapping method of the REG bundle to the REG according to distribution of LTE CRSs in the CORESET comprises:
determining that the mapping method comprises the second method on a condition that the LTE CRSs are distributed on some of the time-domain symbols in the CORESET.

15. The method according to claim 11, wherein the determining the mapping method of the REG bundle to the REG according to distribution of LTE CRSs in the CORESET comprises:
determining a first part of time-domain symbols on which the LTE CRSs are distributed and a second part of time-domain symbols on which the LTE CRSs are not distributed on a condition that the LTE CRSs are distributed on some of the time-domain symbols in the CORESET;
determining a first sub-CORESET that corresponds to the first part of time-domain symbols and is in the CORESET and a second sub-CORESET that corresponds to the second part of time-domain symbols and is in the CORESET; and
determining in the first sub-CORESET that the mapping method comprises the first method, and determining in the second sub-CORESET that the mapping method comprises the first method.

16. The method according to claim 15, wherein the determining the REG bundle in the CORESET according to the mapping method comprises:
mapping a first REG bundle on an REG in the first sub-CORESET according to the first method; and
mapping a second REG bundle on an REG in the second sub-CORESET according to the first method.

17-18. (canceled)

19. A communication apparatus, comprising:
a processor; and
a memory for storing a computer program; wherein the processor is configured to:
determine a mapping method of the REG bundle to a resource element group (REG) according to distribution of long term evolution cell-specific reference signals (LTE CRSs) in a control resource set (CORESET); and
determine the REG bundle in the CORESET according to the mapping method.

20. A communication apparatus, comprising:
a processor; and
a memory for storing a computer program; wherein
the processor is configured to implement the method for mapping an REG bundle according to claim 9.

21. A non-transitory computer-readable storage medium, storing a computer program, wherein the computer program implements when executed by a processor causes the processor to execute the method for determining an REG bundle according to claim 1.

22. A non-transitory computer-readable storage medium, storing a computer program, wherein the computer program implements when executed by a processor causes the processor to execute the method for mapping an REG bundle according to claim 9.
